(19) United States
(12) Patent Application Publication
(10) Pub. No.: US 2006/0219485 A1
(43) Pub. Date: Oct. 5, 2006

(54) Elevator driving apparatus

(76) Inventor: Andrea Maspero, Appiano Gentile (Como) (IT)

Correspondence Address: HEDMAN & COSTIGAN P.C., 1185 AVENUE OF THE AMERICAS, NEW YORK, NY, 10036, US

(21) Appl. No.: 11/395,390

(22) Filed: Mar. 30, 2006

(30) Foreign Application Priority Data
Apr. 5, 2005 (IT) MI2005A000564

(51) Int. Cl. B66B 17/12

(52) U.S. Cl. 187/404

(57) ABSTRACT

An elevator driving apparatus comprises a driving rope extending from a fixed end portion of the elevator cab and a top switching pulley and from the latter to a counterweight pulley, and being then coupled to a counterweight fixed end portion, and being characterized in that said apparatus further comprises a driving motor arranged on the counterweight and driving the counterweight pulley.

### BACKGROUND OF THE INVENTION

The present invention relates to an elevator driving apparatus.

As is known, the driving assembly for operating the cab of an elevator and the like comprises a driving motor, operating the rope coupling the elevator cab and counterweight, directly arranged on the elevator cab.

Such an arrangement, causes the weight of the elevator cab to excessively increase and, accordingly, involves a corresponding increase of the counterweight elements, with the requirement of handling comparatively large masses.

A further problem is that an elevator with its driving motor arranged over the cab, is a rather noisy arrangement, the noise being immediately detected in the elevator cab.

Moreover, a further electromagnetic noise is felt in the elevator cab due to the operating motor arranged thereon.

### SUMMARY OF THE INVENTION

Accordingly, the aim of the present invention is to overcome the above mentioned drawbacks, by providing an apparatus for driving the cab of an elevator and the like, allowing to drastically reduce the weights to be handled or driven, thereby providing a great power saving.

Within the scope of the above mentioned aim, a main object of the present invention is to provide such a driving apparatus allowing to greatly reduce the operating noise as well as the electromagnetic noise which are felt in the elevator cab.

Another object of the present invention is to provide such a driving apparatus which, owing to its specifically designed constructional features, is very reliable and safe in operation.

Yet another object of the present invention is to provide such an elevator driving apparatus which can be easily made starting from easily available elements and materials and which, moreover, is very competitive from a mere economic standpoint.

According to one aspect of the present invention, the above mentioned aim and objects, as well as yet other objects, which will become more apparent hereinafter, are achieved by a driving apparatus for driving a cab of an elevator and the like, comprising a driving rope extending from a fixed portion of the elevator cab to a top switching pulley and from said top switching pulley to a counterweight pulley, and being then connected to a counterweight fixed portion, and being characterized in that said apparatus further comprises a driving motor arranged on the counterweight and operatively driving the counterweight pulley.

### BRIEF DESCRIPTION OF THE DRAWINGS

Further characteristics and advantages of the present invention will become more apparent hereinafter from the following detailed disclosure of a preferred, though not exclusive, embodiment of an apparatus for driving an elevator cab and the like which is illustrated, by way of a merely indicative, but not limitative, example in the accompanying drawings, where:

FIG. 1 is a schematic diagram illustrating the operation of the driving apparatus according to a first aspect of the present invention;

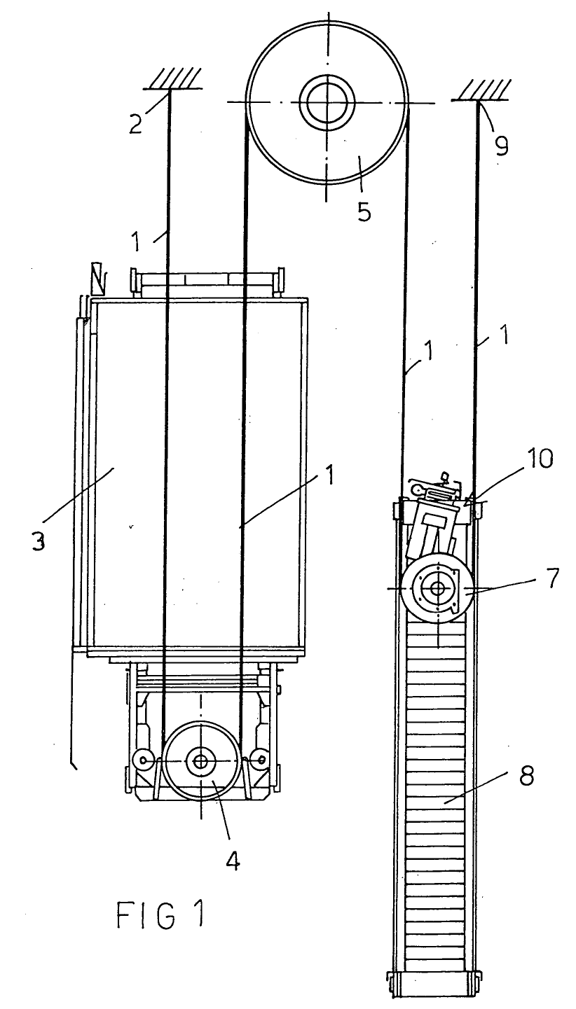

FIG. 2 is a schematic side elevation view showing the elevator cab of FIG. 1;

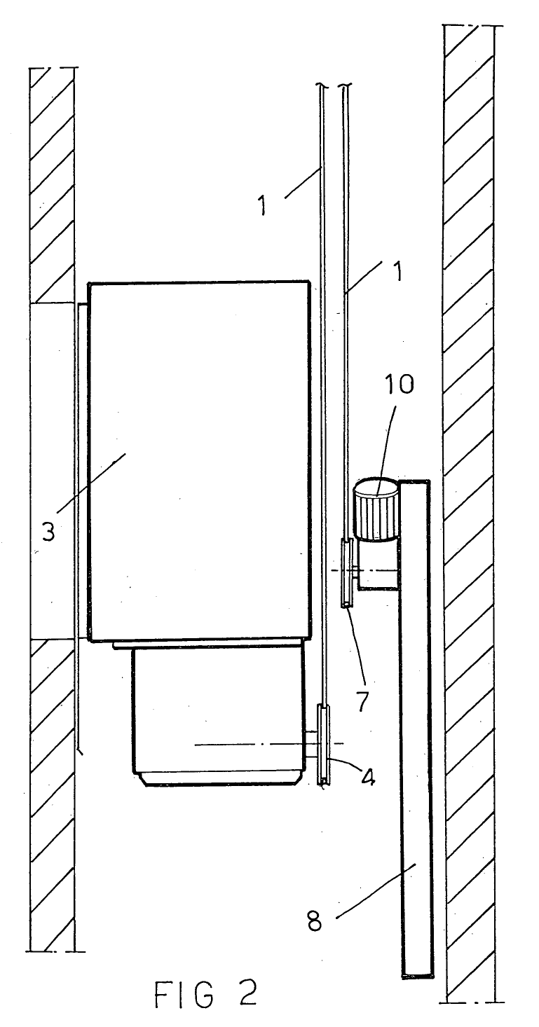

FIG. 3 is a further schematic top plan view showing the elevator cab of FIGS. 1 and 2; and

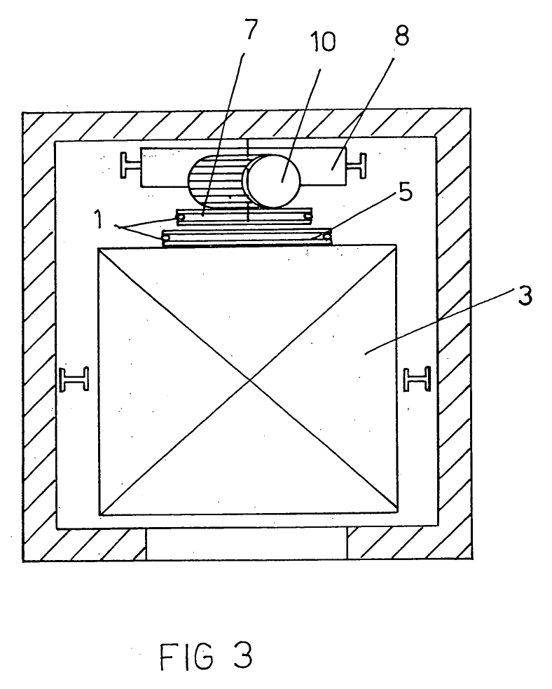

FIG. 4 is a schematic view showing an operation diagram of the driving apparatus according to a further aspect of the present invention.

### DESCRIPTION OF THE PREFERRED EMBODIMENTS

With reference to the number references of the above mentioned figures, the apparatus for driving the cab of an elevator and the like, according to the present invention, comprises a driving rope 1, extending above the elevator cab 3, which, at a bottom portion thereof, supports a cab 3 pulley 4.

The driving rope 1 extends from the pulley 4 of the elevator cab 3 and from the latter to a head or top pulley 5 which is supported on the top portion of the elevator shaft.

More specifically, the driving rope 1 is entrained on a pulley 7 of the elevator counterweight 8 and then is connected to a fixed portion or point of a fixed end portion 9 of the counterweight.

The main feature of the present invention is that the rope driving motor, indicated by the reference number 10 and including a conventional gear-reducing unit, is directly supported by the counterweight 8.

Such an arrangement provides a lot of advantages, the first of which is that of greatly reducing the weight of the elevator cab, since the cab does not support the driving motor.

Moreover, the weight of the motor provides a portion of the counterweight which, accordingly, will include a number of counterweight elements greatly less than that included in prior art arrangements.

The driving apparatus according to the present invention comprises moreover, at one of the elevator paths of movement, a metal cabinet, containing a control panel for controlling or driving the elevator and a plurality of flexible cables extending along the elevator shaft, to power supply the driving motor 10 arranged on the elevator counterweight, in addition to conventional further flexible cables as conventionally used.

The disclosed arrangement allows to use, for driving the elevator cab, both crosswise supported frames and centrally supported frameworks, since the construction of the driving apparatus is not conceptually modified.

In this connection it should be apparent that, by arranging the motor on the elevator counterweight, any noise is further suppressed as well as any further electromagnetic noise source.

From the above disclosure it should be apparent that the invention fully achieves the intended aim and objects.

In particular, the fact is to be pointed out that the novel arrangement of the driving motor allows to obtain a plurality of practical advantages.

The invention, as disclosed, is susceptible to several modifications and variations, all coming within the scope of the invention.

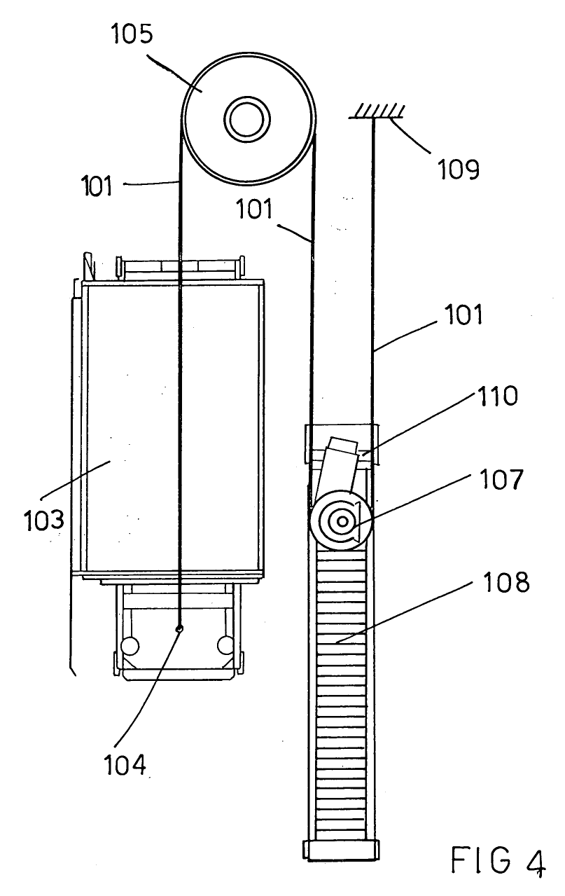

For example, with reference to FIG. 4, the elevator cab driving apparatus, according to a further aspect of the invention, can comprise an operating or driving rope 101 extending from a fixed end portion 104 of the elevator cab, which is arranged at the bottom part of said elevator cab.

More specifically, the driving or operating rope 101 extends from the fixed end portion 104 from the cab to a further region of the elevator driving shaft.

More specifically, the rope 101 extends on a pulley 107 of the counterweight 108 and then is connected to a fixed point of an end fixed portion 109 of the counterweight.

Even in this case, according to the invention, the rope driving motor, indicated by the reference number 110, comprises a conventional gear-reducing unit, directly supported by the counterweight 108.

Thus, the embodiment shown in FIG. 4 provides yet further advantages with respect to the first embodiment.

An advantage of this second embodiment is the elimination of a pulley on the elevator cab supporting construction and a consequent reduction of the overall weight of the cab.

Yet another advantage is a reduction of the length of the used ropes, which length will correspond to the system operating stroke.

All the constructional details can be replaced by other technically equivalent elements.

In practicing the invention, the used materials, as well as the contingent size and shapes, can be any, depending on requirements.

1. A driving apparatus for driving an elevator cab and the like, comprising a driving rope extending from a fixed end portion of the elevator cab and a switching pulley arranged at a top portion the cab and from the latter to a counterweight pulley and being then connected to an end fixed portion of said counterweight, characterized in that said apparatus comprises a driving motor arranged on said counterweight and driving the counterweight pulley.

2. A driving apparatus according to claim 1, characterized in that between the elevator cab end fixed portion and top switching pulley, said driving rope extends on a cab pulley.

3. A driving apparatus according to claim 1, characterized in that said driving motor comprises a gear reducing unit.

4. A driving apparatus according to claim 1, characterized in that said counterweight pulley is arranged on a top portion of the counterweight.

5. A driving apparatus according to claim 1, characterized in that said elevator cab is supported by a crosswise supporting frame.

6. A driving apparatus according to claim 1, characterized in that said elevator cab is supported by any other conventional supporting arrangement.
